(19) United States
(12) Patent Application Publication
(10) Pub. No.: US 2010/0166977 A1
(43) Pub. Date: Jul. 1, 2010

(54) Process for production a thin glasslike coating on substrates for reducing gas permeation

(76) Inventor: Stefan BRAND et al., Sulzbach (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 11/989,580

(22) PCT Filed: Jul. 8, 2006
(86) PCT No.: PCT/EP2006/006696

§ 371 Date: Feb. 24, 2009

(30) Foreign Application Priority Data
Jul. 26, 2005 (DE) 10 2005 034 817.3

(51) Int. Cl. B05D 3/06

(52) U.S. Cl. 427/515

(57) ABSTRACT

A method for producing a glassy, transparent coating on a substrate by coating the substrate with a solution containing a) a polysilazane of the formula

—(SiR′R″—NR′″)ₙ—

where R′, R″, R′″ are identical or different and independently represent hydrogen or an optionally substituted alkyl radical, aryl radical, vinyl radical or (trialkoxysilyl)alkyl radical, n being an integer and or being calculated such that the polysilazane has a number-average molecular weight of from 150 to 150 000 g/mol, and b) a catalyst in an organic solvent, removing the solvent using evaporation such that a polysilazane layer having a layer thickness of 0.05-3.0 μm remains on the substrate, and irradiating the polysilazane layer with VUV radiation having wavelength portions <230 nm and UV radiation having wavelength portions between 230 and 300 nm in an atmosphere containing steam in the presence of oxygen, active oxygen and optional nitrogen.

The present invention relates to a process for converting a thin (0.05-5 μm) coating which comprises, as the main constituent, perhydropolysilazane (also referred to as PHPS) or an organic polysilazane to an impervious glasslike layer which features transparency and a high barrier action toward gases. The conversion is effected by means of irradiation with VUV light with a wavelength of <230 nm and UV light of a wavelength below 300 nm at very low temperatures acceptable for the particular substrate with very short treatment time (0.1-10 min).

It is known (K. Kamiya, T. Tange, T. Hashimoto, H. Nasu, Y. Shimizu, Res. Rep. Fac. Eng. Mie. Univ., 26, 2001, 23-31) that, in the course of heat treatment of PHPS layers, the bonds of the silicon and nitrogen atoms alternating in the polymer skeleton are broken hydrolytically, the nitrogen and some of the hydrogen bonded to the silicon escape as a gaseous compound, for example as ammonia, and the silanols which form crosslink as a result of condensation, which forms a 3D lattice composed of [≡Si—O—] units and having glasslike properties:

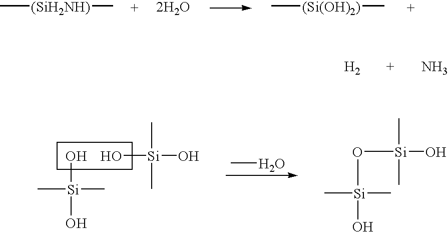

This process can be monitored by ATR-IR spectroscopy with reference to the vanishing Si—NH—Si— and Si—H— bands and the appearing Si—OH— and Si—O—Si bands.

According to the prior art, the conversion can be initiated thermally (EP 0899091 B1, WO 2004/039904 A1). To accelerate the process or to lower the reaction temperature, catalysts based on amines or/and metal carboxylates (Pt, Pd) or/and N-heterocyclic compounds are added (for example WO 2004/039904 A1). At exposure times of from 30 min up to 24 hours, temperatures from room temperature to 400° C. are required for the conversion process, low temperatures requiring long exposure times and high temperatures short exposure times.

EP 0 899 091 B1 also describes the possibility of carrying out the curing of a layer without catalyst in an aqueous 3% triethylamine bath (duration 3 min).

JP 11 166 157 AA describes a process in which a photoabsorber is added to the preceramic polysilazane layer and eliminates amines as a result of UV irradiation. The document proposes wavelengths of 150-400 nm, a power of this radiation of 50-200 mW cm⁻² and treatment times between 0.02 and 10 min.

By virtue of addition of from 0.01 to 30% by weight of photoinitiators, according to JP 11 092 666 AA, polysilazane layers are converted by UV light with wavelengths greater than 300 nm at 50 mW cm⁻² and a treatment time of around 30 s. In addition, the curing rate can be increased by adding oxidizing metal catalysts (Pt, Pd, Ni . . . ).

According to JP 10 279 362 AA, polysilazane layers (mean molecular weight 100-50 000) are applied to polyester films (5 nm-5 μm). Here too, the oxidation reaction at low temperatures is accelerated with Pt or Pd catalysts and/or an amine compound. The latter compounds can be introduced as a constituent of the polysilazane coating, as an aqueous solution in an immersion bath or as a vapor component in the ambient air during the heat treatment. In addition, simultaneous irradiation with 150-400 nm UV light is proposed in order to activate the amine catalysts acting as photoabsorbers. The UV sources mentioned are high- and low-pressure mercury vapor lamps, carbon and xenon arc lamps, excimer lamps (wavelength regions 172 nm, 222 nm and 308 nm) and UV lasers. At treatment times of 0.05-3 min, a UV power of 20-300 mW cm⁻² is required. A subsequent heat treatment up to 150° C. for from 10 to 60 min at a high steam content (50-100% relative humidity) is said to further improve the layer properties, explicitly with regard to the gas barrier action. The support materials mentioned for the ceramized polysilazane layer also include films of plastics material such as PET, PI, PC, PS, PMMA, etc. Application methods for the polysilazane layer are dip painting cloth, roll coating, bar spreading, web spreading, brush coating, spray spreading, flow coating, etc. The layer thicknesses obtained after the conversion are around 0.4 μm.

For the coating of heat-sensitive plastics films, JP 10 212 114 AA describes a conversion of the polysilazane layer by means of IR irradiation to activate optionally present amines or metal carboxylates, which is intended to accelerate the conversion of the layer. JP 10 279 362 AA also mentions the simultaneous use of UV and IR radiation as beneficial for the layer conversion, far IR (4-1000 μm) being preferable because it heats the support film less strongly.

The conversion of polysilazane by electron irradiation is described in JP 08 143 689 AA.

For the production of thin protective layers for magnetic strips, EP 0 745 974 B1 describes oxidation methods using ozone, atomic oxygen and/or irradiation with VUV photons in the presence of oxygen and steam. This allows the treatment times at room temperature to be lowered to a few minutes. The mechanism mentioned is the oxidative action of ozone or oxygen atoms. The optionally used VUV radiation serves exclusively to generate these reactive species. Simultaneous heat supply up to the tolerance limit of the substrate (PET 180° C.) achieved conversion times in the range from a few seconds to a few minutes for polysilazane layers around 20 nm. In the strip coating described, the heat can be supplied by close contact with heated rollers.

The UV radiation sources mentioned are lamps which contain radiation fractions with wavelengths below 200 nm: for example low-pressure mercury vapor lamps with radiation fractions around 185 nm and excimer lamps with radiation fractions around 172 nm. Another method mentioned for improving the layer properties is the mixing-in of the fine (5 nm-40 nm) inorganic particles (silica, alumina, zirconia, titania . . . ).

The coatings produced with the aforementioned process require, even though they only have a layer thickness of from 5 to 20 nm, a relatively long curing time. Owing to the low film thickness, void formation is quite high and the barrier action of the coatings is unsatisfactory.

It is therefore an object of the invention to provide a process for producing transparent coatings, which allows even thermally sensitive substrates to be coated in a simple and economically viable manner, and for the coatings thus obtained to feature a high barrier action with respect to gases.

The present invention achieves this object and relates to a process for producing a glasslike, transparent coating on a substrate, by coating the substrate with a solution comprising a) a polysilazane of the formula (I)

—(SiR′R″—NR′″)ₙ— (1)

where R′, R″, R′″ are the same or different and are each independently hydrogen or an optionally substituted alkyl, aryl, vinyl or (trialkoxysilyl)alkyl radical, preferably a radical from the group of hydrogen, methyl, ethyl, propyl, isopropyl, butyl, isobutyl, tert-butyl, phenyl, vinyl or 3-(triethoxysilyl)propyl, 3-(trimethoxysilylpropyl), where n is an integer and n is such that the polysilazane has a number-average molecular weight of from 150 to 150 000 g/mol, and b) a catalyst in an organic solvent, subsequently removing the solvent by evaporation to leave a polysilazane layer having a layer thickness of 0.05-3.0 μm on the substrate, and irradiating the polysilazane layer with VUV radiation with wavelength fractions <230 nm and UV radiation with wavelength fractions between 230 and 300 nm in a steam-containing atmosphere in the presence of oxygen, active oxygen and optionally nitrogen.

The catalyst used is preferably a basic catalyst, in particular N,N-diethylethanolamine, N,N-dimethylethanolamine, triethanolamine, triethylamine, 3-morpholinopropylamine or N-heterocyclic compounds. The catalyst concentrations are typically in the range from 0.1 to 10 mol % based on the polysilazane, preferably from 0.5 to 7 mol %.

In a preferred embodiment, solutions are used which comprise at least one perhydropolysilazane of the formula 2.

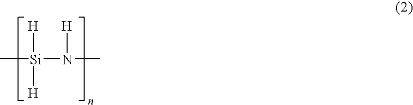

In a further preferred embodiment, the inventive coating comprises at least one polysilazane of the formula (3)

—(SiR′R″—NR′″)ₙ—(SiR*R**—NR***)ₚ— (3)

where R′, R″, R′″, R*, R** and R*** are each independently hydrogen or an optionally substituted alkyl, aryl, vinyl or (trialkoxysilyl)alkyl radical, where n and p are each an integer and n is such that the polysilazane has a number-average molecular weight of from 150 to 150 000 g/mol.

Especially preferred are compounds in which
R′, R′″ and R*** are each hydrogen and R″, R* and R** are each methyl;
R′, R′″ and R*** are each hydrogen and R″, R* are each methyl and R** is vinyl; or
R′, R′″, R* and R*** are each hydrogen and R″ and R** are each methyl.

Likewise preferred are solutions which comprise at least one polysilazane of the formula (4)

—(SiR′R″—NR′″)ₙ—(SiR*R**—NR***)ₚ—(SiR¹, R²—NR³)_{q}— (4)

where R′, R″, R′″, R*, R**, R***, R¹, R² and R³ are each independently hydrogen or an optionally substituted alkyl, aryl, vinyl or (trialkoxysilyl)alkyl radical, where n, p and q are each an integer and n is such that the polysilazane has a number-average molecular weight of from 150 to 150 000 g/mol.

Especially preferred compounds are those in which R′, R′″ and R*** are each hydrogen and R″, R*, R** and R² are each methyl, R³ is (triethoxysilyl)propyl and R¹ is alkyl or hydrogen.

In general, the content of polysilazane in the solvent is from 1 to 80% by weight of polysilazane, preferably from 5 to 50% by weight, more preferably from 10 to 40% by weight.

Suitable solvents are particularly organic, preferably aprotic solvents which do not contain water or any reactive groups (such as hydroxyl or amine groups) and behave inertly toward the polysilazane. They are, for example, aliphatic or aromatic hydrocarbons, halohydrocarbons, esters such as ethyl acetate or butyl acetate, ketones such as acetone or methyl ethyl ketone, ethers such as tetrahydrofuran or dibutyl ether, and mono- and polyalkylene glycol dialkyl ethers (glymes) or mixtures of these solvents.

An additional constituent of the polysilazane solution may be further binders, as used customarily for the production of coatings. They may, for example, be cellulose ethers and esters such as ethylcellulose, nitrocellulose, cellulose acetate or cellulose acetobutyrate, natural resins such as rubber or rosins, or synthetic resins such as polymerization resins or condensation resins, for example amino resins, in particular urea- and melamine-formaldehyde resins, alkyd resins, acrylic resins, polyesters or modified polyesters, epoxides, polyisocyanates or blocked polyisocyanates, or polysiloxanes.

A further constituent of the polysilazane formulation may be additives which, for example, influence viscosity of the formulation, substrate wetting, film formation, lubrication or the venting behavior, or inorganic nanoparticles, for example SiO₂, TiO₂, ZnO, ZrO₂ or Al₂O₃.

The process according to the invention makes it possible to produce an impervious glasslike layer which features a high barrier action with respect to gases owing to its freedom from cracks and pores.

The coatings produced have a layer thickness of from 100 nm to 2 μm.

The substrates used in accordance with the invention are thermally sensitive plastics films or plastics substrates (for example three-dimensional substrates such as PET bottles) with thicknesses of 10-100 μm, in particular films or substrates made of polyethylene terephthalate (PET), polyethylene naphthalate (PEN), polyimide (PI), polypropylene (PP), polyethylene (PE), to name just a few examples. In a further preferred embodiment, it is also possible to coat substrates such as metal films, for example aluminum and titanium films.

The outstanding barrier action with respect to gases, especially with respect to steam, oxygen and carbon dioxide, makes the inventive coatings particularly useful as barrier layers for packaging materials and as protective layers against corrosive gases, for example for coating vessels or films for the foods industry. The process according to the invention succeeds in converting the amorphous polysilazane layers applied in a first step to a glasslike silicon dioxide network at temperatures below 100° C. within from 0.1 to 10 min. This allows coating on films from roll to roll with transport speeds above 1 m min⁻¹. For this purpose, the processes known to date in the prior art either needed a plurality of process steps or the conversion had to be performed at higher temperatures and with greater time demands.

As a result of direct initiation of the oxidative conversion of the polysilazane skeleton to a three-dimensional SiOₓ network by VUV photons, the conversion succeeds within a very short time with a single step. The mechanism of this conversion process can be explained in that the —SiH₂—NH units in the region of the penetration depth of the VUV photons are excited so greatly by absorption that the Si—N bond breaks and, in the presence of oxygen and steam, the conversion of the layer proceeds.

Radiation sources suitable in accordance with the invention are excimer radiators having an emission maximum around 172 nm, low-pressure mercury vapor lamps having an emission line around 185 nm, and medium- and high-pressure mercury vapor lamps having wavelength fractions below 230 nm and excimer lamps having an emission maximum around 222 nm.

In the case of use of radiation sources with radiation fractions with wavelengths below 180 nm, for example Xe₂* excimer radiators with an emission maximum around 172 nm, ozone and oxygen or hydroxyl radicals are formed very efficiently by photolysis in the presence of oxygen and/or steam owing to the high absorption coefficients of these gases in this wavelength range, and promote the oxidation of the polysilazane layer. However, both mechanisms, splitting of the Si—N bond and action of ozone, oxygen radicals and hydroxyl radicals, can act only when the VUV radiation also reaches the surface of the polysilazane layer.

In order to bring a maximum dose of VUV radiation to the surface of the layer, it is therefore necessary for this wavelength range to lower the oxygen concentration and the steam concentration of the path length of the radiation accordingly in a controlled manner by optionally purging the VUV treatment channel with nitrogen, to which oxygen and steam can be added in a controllable manner.

The oxygen concentration is preferably in the range of 500-210 000 ppm.

Steam concentration during the conversion process has been found to be advantageous and reaction-promoting, so that preferably a steam concentration of from 1000 to 4000 ppm.

In an embodiment preferred in accordance with the invention, the irradiation of the layers is carried out in the presence of ozone. In this way, the active oxygen which is required for the performance of the process can be formed in a simple manner by decomposition of the ozone during the irradiation.

The action of UV light without wavelength fractions below 180 nm from HgLP lamps (185 nm) or KrCl* excimer lamps (222 nm) is restricted to the direct photolytic action on the Si—N bond, i.e. no oxygen or hydroxyl radicals are formed. In this case, owing to the negligible absorption, no restriction of the oxygen and steam concentration is required. Another advantage over shorter-wavelength light consists in the greater penetration depth into the polysilazane layer.

According to the invention, the irradiation with the VUV radiation and the UV radiation can be effected simultaneously, successively or alternately, both with VUV radiation below 200 nm, in particular below 180 nm, of with VUV radiation with wavelength fractions from 180 to 200 nm, and with UV radiation with wavelength fractions between 230 and 300 nm, in particular with UV radiation in the range from 240 to 280 nm. In this case, a synergistic effect can arise by virtue of ozone formed by the radiation with wavelength fractions below 200 nm being degraded by radiation with wavelength fractions between 230 and 300 nm to form oxygen radicals (active oxygen).

O₂+hv(<180 nm)→O(³P)+O(¹D)

O(³P)+O₂→O₃

O₃+hv(<300 nm)→O₂(¹Δg)+O(¹D)

When this process takes place at the layer surface or in the layer itself, the process of layer conversion can be accelerated. Suitable radiation sources for such a combination are Xe₂* excimer radiators with wavelength fractions around 172 nm and low-pressure or medium-pressure mercury lamps with wavelength fractions around 254 nm or in the range of 230-280 nm.

According to the invention, the formation of a glasslike layer in the form of an SiOₓ lattice is accelerated by simultaneous temperature increase of the layer and the quality of the layer with regard to its barrier properties rises.

The heat input can be effected by the UV lamps used or by means of infrared radiators through the coating and the substrate, or by means of heating registers through the gas space. The upper temperature limit is determined by the thermal stability of the substrate used. For PET films, it is about 180° C.

In a preferred embodiment of the invention, the substrate is heated during the oxidative conversion process by means of infrared radiators to temperatures between 50 and 200° C. (depending on the thermal sensitivity of the substrate to be coated) and simultaneously exposed to irradiation. In a further preferred embodiment, the gas temperature in the irradiation chamber during the conversion process is increased to temperatures of from 50 to 200° C. and simultaneous heating of the coating on the substrate is thus achieved, which leads to accelerated conversion of the polysilazane layers.

The barrier action of the layers with respect to gases can be determined by permeation measurements, and by means of ATR-IR measurement with regard to the residual content of Si—H and Si—NH—Si bonds and the Si—OH and Si—O—Si bonds which form. The morphology of the layers is typically determined by means of SEM analyses. Concentration gradients of nitrogen and SiOₓ at right angles to the layer surface are determined in the simplest way by SIMS.

The process according to the invention allows coating, drying and oxidative conversion by irradiation of the polysilazane layer on the plastics film to be carried out in one working step, i.e., for example, in the coating of films “from roll to roll”. The coatings obtained in accordance with the invention feature high barrier action with respect to gases, for example oxygen, carbon dioxide, air or else with respect to steam.

The barrier action can, when it is desired, be increased further by multiple, successive performance of the process according to the invention, which is, however, generally not necessary.

### EXAMPLES

Substrates:

Polyethylene terephthalate (PET), polyethylene naphthalate (PEN), polyimide (PI), polyethylene (PE), polypropylene (PP).

Polysilazane Solutions:

Perhydropolysilazane solution in xylene (NP110, NN110 from Clariant GmbH) or in dibutyl ether (NL120, NN120 from Clariant GmbH).

Addition of a basic catalyst (for example N,N-diethylethanolamine, triethanolamine, triethylamine, 3-morpholinopropylamine, N-heterocyclic carbenes).

(From 1 to 5% of catalyst on polysilazane solid).

Coating Process:

Dipping, from roll to roll, spin-coating. Then dried at 100° C. for 5 min.

Oxidative Conversion:

Conversion of perhydropolysilazane (PHPS) to SiOₓ network by VUV radiation by means of Xe₂* excimer radiators, emission around 172 nm, VUV power 30 mW cm⁻², by means of low-pressure mercury vapor lamp (HgLP lamp), emission line at 185 nm, VUV power 10 mW cm⁻².

The resulting SiOₓ films have layer thicknesses between 200 and 500 nm (SEM, ellipsometry).

Determination of the Barrier Values:

OTR (Oxygen Transmission Rate) at 23° C. and 0% r.h. or 85% r.h.

WVTR (Water Vapor Transmission Rate) at 23° C. or 40° C. and 90% r.h.

For an approx. 200 nm SiOₓ layer, OTR=0.5-0.8 cm³ m⁻² day⁻¹ bar⁻¹

For an approx. 300 nm SiOₓ layer, the values are between OTR=0.1-0.4 cm³ m⁻² day⁻¹ bar⁻¹ and WVTR=0.5-1.0 g m⁻² day⁻¹ bar⁻¹.

For two SiOₓ layers (approx. 400 nm in total),

OTR=0.05-0.15 cm³ m⁻² day⁻¹ bar⁻¹ and WVTR=0.2-0.4 g m⁻² day⁻¹ bar⁻¹.

For three SiOₓ layers (approx. 500 nm in total),

OTR<0.03 cm³ m⁻² day⁻¹ bar⁻¹ and WVTR<0.03 g m⁻² day⁻¹ bar⁻¹.

### Example 1

36 μm PET film coated with 3% perhydropolysilazane solution in xylene (NP110) or dibutyl ether (NL120) by dipping, dried at 100° C. for 5 min, converted oxidatively with Xe₂* excimer radiation 30 mW cm⁻² (1 min, 2500 ppm of O₂, 10% r.h.), layer thickness approx. 300 nm.

OTR (23° C., 0% r.h.)=0.2 or 0.3 cm³ m⁻² day⁻¹ bar⁻¹

Uncoated comparative film: OTR for 36 μm PET film=45-50 cm³ m⁻² day⁻¹ bar⁻¹

Barrier Improvement Factor (BIF)=OTR (uncoated)/OTR (coated)

BIF (NP110)=225-250 and BIF (NL120)=150-167

### Example 2

36 μm PET film coated with 3% perhydropolysilazane solution in xylene (NP110) or dibutyl ether (NL120), addition of amino catalyst (5% triethanolamine based on PHPS), coating by dipping, dried at 100° C. for 5 min, converted oxidatively with Xe₂* excimer radiation 30 mW cm⁻² (1 min, 2500 ppm of O₂, 10% r.h.), layer thickness approx. 300 nm.

OTR (23° C., 0% r.h.)=0.14 and 0.24 cm³ m⁻² day⁻¹ bar⁻¹

Uncoated comparative film: OTR=45-50 cm³ m⁻² day⁻¹ bar⁻¹

BIF (NP110+cat)=321-357 and BIF (NL120+cat)=188-208

WVTR (23° C., 90% r.h.)=1.0 g m⁻² day⁻¹ bar⁻¹

### Example 3

36 μm PET film coated with 3% perhydropolysilazane solution in xylene (NN110) or dibutyl ether (NN120), addition of amino catalyst (5% N,N-diethylethanolamine based on PHPS), coating by dipping, dried at 100° C. for 5 min, converted oxidatively with Xe₂* excimer radiation 30 mW cm⁻² (1 min, 2500 ppm of O₂, 10% r.h.), layer thickness approx. 300 nm.

OTR (23° C., 0% r.h.)=0.4 and 0.2 cm³ m⁻² day⁻¹ bar⁻¹

Uncoated comparative film: OTR=45-50 cm³ m⁻² day⁻¹ bar⁻¹

BIF (NN110+cat)=113-125 and BIF (NN120+cat)=225-250

### Example 4

36 μm PET film coated with 3% perhydropolysilazane solution in xylene (NP110), addition of 5% amino catalyst based on PHPS (N,N-diethylethanolamine, triethylamine, triethanolamine), coating by dipping, dried at 100° C. for 5 min, converted oxidatively with Xe₂* excimer radiation 30 mW cm⁻² (1 min, 2500 ppm of O₂, 10% r.h.) or thermally at 65° C. for 30 min, layer thickness approx. 300 nm.

| | OTR/cm³ m⁻² d⁻¹ bar⁻¹ at 0% r.h. | |
|---|---|---|
| Sample | VUV | Thermally |
| PET uncoated | 45 to 50 | |
| NP110 + N,N-diethylethanolamine | 0.3 | 44 |
| NP110 + triethylamine | 0.2 | 51 |
| NP110 + triethanolamine | 0.14 | 50 |

### Example 5

36 μm PET film coated with 3% perhydropolysilazane solution in xylene (NP110), addition of 5% amino catalyst based on PHPS (N,N-diethylethanolamine), coating by dipping, dried at 100° C. for 5 min, converted oxidatively with Xe₂* excimer radiation 30 mW cm⁻² (1 min, 2500 ppm of O₂, 10% r.h.) and then coated once more in the same way, dried and converted oxidatively: two SiOₓ layers in total, layer thickness 400-500 nm.

OTR (23° C., 0% r.h.)=0.05-0.1 cm³ m⁻² day⁻¹ bar⁻¹

WVTR (23° C., 90% r.h.)=0.2 g m⁻² day⁻¹ bar⁻¹

### Example 6

36 μm PET film coated with 3% perhydropolysilazane solution in xylene (NP110), addition of 5% amino catalyst based on PHPS (N,N-diethylethanolamine), coating by dipping, dried at 100° C. for 5 min, converted oxidatively with Xe₂* excimer radiation 30 mW cm⁻² (1 min, 2500 ppm of O₂, 10% r.h.) and then coated twice more in the same way, dried and converted oxidatively: three SiOₓ layers in total, layer thickness 500-600 nm.

OTR (23° C., 0% r.h.)=0.01-0.03 cm³ m⁻² day⁻¹ bar⁻¹

WVTR (23° C., 90% r.h.)=0.03 g m⁻² day⁻¹ bar⁻¹

### Example 7

36 μm PET film coated with 3% perhydropolysilazane solution in xylene (NP110) addition of 5% amino catalyst based on PHPS (N,N-diethylethanolamine), coating by dipping, dried at 100° C. for 5 min, converted oxidatively with HgLP radiation, VUV output 10 mW cm⁻² (10 min, 2500 ppm of O₂, 10% r.h.), layer thickness approx. 300 nm.

OTR (23° C., 0% r.h.)=0.2 cm³ m⁻² day⁻¹ bar⁻¹

### Example 8

23 μm PET film coated with 3% perhydropolysilazane solution in xylene (NP110) or dibutyl ether (NL120), addition of 5% amino catalyst based on PHPS (N,N-diethylethanolamine), roll-to-roll coating, converted oxidatively with Xe₂* excimer radiation (double lamp, 120 cm, oblique) 33 mW cm⁻² (3 m min⁻¹, 2500 ppm of O₂, 6% r.h.), layer thickness approx. 400 nm.

OTR (23° C., 0% r.h.)=0.65 and 0.35 cm³ m⁻² day⁻¹ bar⁻¹

### Example 9

PET film coated with polysilazane solution in xylene or dibutyl ether, addition of amino catalyst, roll-to-roll coating, converted oxidatively with Xe₂* excimer radiation 30 mW cm⁻² (O₂, H₂O)+thermally, layer thickness approx. 300 nm.

### Example 10

PET bottles coated with polysilazane solution in xylene and dibutyl ether, addition of amino catalyst, coating by dipping, dried at 65° C. for 5 min, converted oxidatively with Xe₂* excimer radiation 30 mW cm⁻² (5 min, 2500 ppm of O₂, 10% r.h.), layer thickness approx. 400 nm.

Barrier Improvement Factor (BIF)=10 for O₂ and =3 for CO₂.

### Example 11

23 μm PET film coated with 3% perhydropolysilazane solution in dibutyl ether (NL120), addition of 5% amino catalyst based on PHPS (N,N-diethylethanolamine), roll-to-roll coating, converted oxidatively with Xe₂* excimer radiation 250 mJ cm⁻² and Hg-LP radiation 250 mJ cm⁻² (1 m min⁻¹, 2500 ppm of O₂, 7% r.h.), layer thickness approx. 400 nm. Gas feed against running direction from excimer radiator to Hg-LP radiators

OTR (23° C., 0% r.h.)

### Example 12

23 μm PET film coated with 3% perhydropolysilazane solution in dibutyl ether (NL120), addition of 5% amino catalyst based on PHPS (N,N-diethylethanolamine), roll-to-roll coating, converted oxidatively with Xe₂* excimer radiation 250 mJ cm⁻² and Hg-LP radiation 250 mJ cm⁻² (1 m min⁻¹, 10 000 ppm of O₂, 7% r.h.), layer thickness approx. 400 nm. Gas feed against running direction from excimer radiator to Hg-LP radiators

OTR (23° C., 0% r.h.)=1.0 cm³ m⁻² day⁻¹ bar⁻¹

### Example 13

23 μm PET film coated with 3% perhydropolysilazane solution in dibutyl ether (NL120), addition of 5% amino catalyst based on PHPS (N,N-diethylethanolamine), roll-to-roll coating, converted oxidatively with Xe₂* excimer radiation 100 mJ cm⁻² and Hg-LP radiation 250 mJ cm⁻² (1 m min⁻¹, 2500 ppm of O₂, 250 ppm of ozone, 7% r.h.), layer thickness approx. 400 nm. Gas feed against running direction from excimer radiator to Hg-LP radiators

OTR (23° C., 0% r.h.)=0.75 cm³ m⁻² day⁻¹ bar⁻¹

### Example 14

23 μm PET film coated with 3% perhydropolysilazane solution in dibutyl ether (NL120), addition of 5% amino catalyst based on PHPS (N,N-diethylethanolamine), roll-to-roll coating, converted oxidatively with Xe₂* excimer radiation 500 mJ cm⁻² and Hg-LP radiation 250 mJ cm⁻² (1 m min⁻¹, 2500 ppm of O₂, 100 ppm of ozone, 7% r.h.), layer thickness approx. 400 nm. Gas feed against running direction from excimer radiator to Hg-LP radiators

OTR (23° C., 0% r.h.)

TABLE 1
Penetration of radiation (I/I₀ = 1/e = 36.8%) of wavelength 162, 172
and 182 nm into nitrogen-oxygen mixtures of various concentration

| Oxygen | Penetration (I/I₀ = 1/e) | | | | | |
|---|---|---|---|---|---|---|
| concentration | 162 nm radiation | | 172 nm radiation | | 182 nm radiation | |
| 20% | 0.45 | mm | 3 | mm | 10 | cm |
| 5% | 1.8 | mm | 1.2 | cm | 40 | cm |
| 1% | 9.1 | mm | 6.0 | cm | 2 | m |
| 2500 ppm | 3.6 | cm | 24 | cm | 8 | m |
| 1000 ppm | 9.1 | cm | 60 | cm | 20 | m |
| 100 ppm | 91 | cm | 6 | m | 200 | m |

1. A process for producing a glasslike, transparent coating on a substrate, comprising the steps of coating a surface of the substrate with a solution comprising a) a polysilazane of the formula (I)
—(SiR′R″—NR′″)ₙ— (1)
where R′, R″, R′″ are the same or different and are each independently hydrogen or an optionally substituted alkyl, aryl, vinyl or (trialkoxysilyl)alkyl radical, where n is an integer and n is such that the polysilazane has a number-average molecular weight of from 150 to 150 000 g/mol, and
b) a catalyst in an organic solvent,
removing the solvent by evaporation to form a polysilazane layer having a layer thickness of 0.05-3.0 μm on the substrate, and irradiating the polysilazane layer with VUV radiation with wavelength fractions <230 nm and UV radiation with wavelength fractions between 230 and 300 nm in a steam-containing atmosphere in the presence of oxygen, active oxygen and optionally nitrogen.

2. The process as claimed in claim 1, wherein the catalyst is a basic catalyst, in particular N,N-diethylethanolamine, N,N-dimethylethanolamine, triethanolamine, triethylamine, 3-morpholinopropylamine or N-heterocyclic compounds.

3. The process as claimed in claim 1, wherein the solvent is an aprotic solvent inert toward the polysilazane.

4. The process as claimed in claim 1, wherein the solution contains from 1 to 80% by weight of the polysilazane.

5. The process as claimed in claim 1, wherein VUV radiation with wavelength fractions <180 nm is used.

6. The process as claimed in claim 1, wherein VUV radiation with wavelength fractions in the range from 180 to 230 nm is used.

7. The process as claimed in claim 1, wherein the irradiating step with the VUV and UV radiation is effected simultaneously, successively or alternately.

8. The process as claimed in claim 1, wherein the oxygen concentration is 500-210 000 ppm.

9. The process as claimed in claim 1, wherein the steam concentration is from 1000 to 4000 ppm.

10. The process as claimed in claim 1, wherein ozone is present during the irradiating step.

11. The process as claimed in claim 1, wherein R′, R″, R′″ in formula (1) are each independently a radical selected from the group consisting of hydrogen, methyl, ethyl, propyl, isopropyl, butyl, isobutyl, tert-butyl, phenyl, vinyl 3-(triethoxysilyl)propyl and 3-(trimethoxysilylpropyl).

12. The process as claimed in claim 1, wherein the solution comprises at least one perhydropolysilazane of the formula (2)

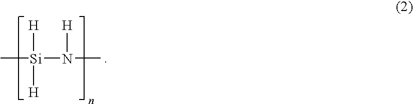

13. The process as claimed in claim 1, wherein the solution comprises at least one polysilazane of the formula (3)
—(SiR′R″—NR′″)ₙ—(SiR*R**—NR***)ₚ— (3)
where R′, R″, R′″, R*, R** and R*** are each independently hydrogen or an optionally substituted alkyl, aryl, vinyl or (trialkoxysilyl)alkyl radical, where n and p are each an integer and n is such that the polysilazane has a number-average molecular weight of from 150 to 150 000 g/mol.

14. The process as claimed in claim 13, wherein, in formula (3)
R′, R′″ and R*** are each hydrogen and R″, R* and R** are each methyl;
R′, R′″ and R*** are each hydrogen and R″, R* are each methyl and R** is vinyl; or
R′, R′″, R* and R*** are each hydrogen and R″ and R** are each methyl.

15. The process as claimed in claim 1, wherein the solution comprises at least one polysilazane of the formula (4)
—(SiR′R″—NR′″)ₙ—(SiR*R**—NR***)ₚ—(SiR¹, R²—NR³)_{q}—
where R′, R″, R′″, R*, R**, R***, R¹, R² and R³ are each independently hydrogen or an optionally substituted alkyl, aryl, vinyl or (trialkoxysilyl)alkyl radical, where n, p and q are each an integer and n is such that the polysilazane has a number-average molecular weight of from 150 to 150 000 g/mol.

16. The process as claimed in claim 1, wherein the substrate, during the irradiating step is heated by infrared radiators to temperatures between 50 and 200° C., in accordance with the thermal stability of the substrate.

17. The process as claimed in claim 1, wherein the irradiating step occurs in an irradiation chamber and the gas temperature in the irradiation chamber is heated to temperatures between 50 and 200° C., in accordance with the thermal stability of the substrate.

18. The process as claimed in claim 1, wherein the substrate is a plastics film having a thickness in the range from 10 to 100 μm.

19. The process as claimed in claim 1, wherein the substrate is a polyethylene terephthalate, polyethylene naphthalate, polyimide, polypropylene or polyethylene film.

20. The process as claimed in claim 18, wherein the coating, coating step and irradiating step of the polysilazane layer and removing of the solvent on the plastics film are effected in one working step from roll to roll.

21. The process as claimed in claim 2, wherein the basic catalyst is selected from the group consisting of N,N-diethylethanolamine, N,N-dimethylethanolamine, triethanolamine, triethylamine, 3-morpholinopropylamine and N-heterocyclic compounds.

22. The process as claimed in claim 1, wherein the solution contains from 5 to 50% by weight of the polysilazane.

23. The process as claimed in claim 1, wherein the solution contains from 10 to 40% by weight of the polysilazane.

24. A process for producing a glasslike, transparent coating on a substrate, comprising the steps of coating a surface of the substrate with a solution comprising at least one perhydropolysilazane of the formula (2) 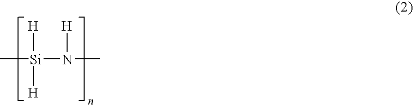
and
b) a catalyst in an organic solvent,
removing the solvent by evaporation to form a polysilazane layer having a layer thickness of 0.05-3.0 μm on the substrate, and irradiating the polysilazane layer with VUV radiation with wavelength fractions <230 nm and UV radiation with wavelength fractions between 230 and 300 nm in a steam-containing atmosphere in the presence of oxygen, active oxygen and optionally nitrogen.
